(19) United States
(12) Patent Application Publication
(10) Pub. No.: US 2002/0052786 A1
(43) Pub. Date: May 2, 2002

(54) Informative system based on user's position and operating method thereof

(75) Inventors: Byoung Wook Kim, Seoul (KR); Ki Chul Bae, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 09/923,359

(22) Filed: Aug. 8, 2001

(30) Foreign Application Priority Data
Aug. 9, 2000 (KR) 46121/2000
Dec. 6, 2000 (KR) 73780/2000
Dec. 14, 2000 (KR) 76420/2000

(51) Int. Cl. G06F 17/60; G01C 21/26; G01C 21/28; G01C 21/30; G01C 21/32; G01C 21/34; G01C 21/36

(52) U.S. Cl. 705/14; 701/200

(57) ABSTRACT

An informative system and an operating method thereof are disclosed. The system and method can provide special information service based on the present position of a user. The informative service system includes a local CP(Contents Provider) network having a prescribed service supply range of each region, receiving at least one of information of various stores, companies, real estates and so on in the region, information effective only in the corresponding region and other information requested by a client, the local CP network transmitting the received information to a terminal of the client who is located within the region; and a position confirmation network continuously confirming the client's position through the client's own terminal and providing the confirmed position information of the client to the local CP network. The operating method of the informative service system includes the steps of: continuously confirming the location of a terminal set to receive various services; and collecting special information required for supply of traffic information in a region through a local CP network constructed in the region when it is confirmed through pilot signal transmitted from a client's terminal that the client's terminal enters the region and transmitting the collected information to the client's terminal.

### BACKGROUND OF THE INVENTION

1. Field of the Invention

The present invention relates to a service system for providing users with information, and more particularly, to an informative system and an operating method thereof, which can provide special information service based on the present position of a user.

2. Background of the Related Art

In general, clients cannot exactly know about which store of various stores (especially, stores providing the same services) is better in an unknown region when visiting the region. Especially, if wanting to visit a restaurant for a meal in the unknown region, the client cannot help visiting the restaurant at random in consideration of acquaintances' recommendation, position of the restaurant, cleanliness of the restaurant or the client's taste.

Presently, according to the rapid development in the communication industry, advertisement and information of stores in every region are disclosed on the Internet, and thereby, the client can previously obtain information of the stores located in the client's desired region.

That is, the client can easily obtain information of the special stores and information of evaluation by each store by connecting to the Internet through the client's terminal. Moreover, the client could easily choose the desired store on the basis of the known information when visiting the corresponding region later.

However, the above services are provided only through the Internet, and therefore, when visiting the unknown region without any provision, the client cannot obtain information of various stores in the region.

Meanwhile, various stores or companies managed through a conventional method of managing branch stores upload advertisement of the corresponding stores or companies on the Internet to advertise the stores or companies in the whole area, thereby reducing the total advertisement fee and obtaining ad effects of brand name of the corresponding stores or companies.

However, because the clients have different tastes according to regional peculiarities, it is difficult to attract the clients to the stores or companies through the above ad method.

Therefore, to attract the clients according to the regional peculiarities, an attempt for attracting the clients according to the regional peculiarities by showing news occurring in each regional branch store or agency on separate sections of the online homepage managed by the corresponding company has been tried. However, it could not arouse the clients' interest.

Thus, till now, the advertisement has depended on the methods of advertising through handbills for ad of the corresponding region or through local newspapers.

Especially, as described above, in case of the stores or companies of the special region without being managed by the method of managing branch stores, it is more effective to advertise to the clients, who live in the near area, than to the whole region, and thus it is unavoidable to advertise through the handbills and the local newspapers.

Meanwhile, the clients want to promptly obtain desired information in the time of need. Especially, the client wants to promptly obtain information such as the present events (traffic condition, information of the corresponding area, and so on), information of each store, information of real estates within the corresponding region when visiting the unknown region.

However, till now, because there have been no service satisfying the clients' desire, the clients must directly find information of the corresponding region.

For example, if entering a certain region and wanting to obtain information of real estate (special building) inside the corresponding region, the client has to directly visit a real estate mediator, who lives in the region, to obtain information of the real estate.

Furthermore, the client could not help experiencing many difficulties because not exactly knowing regulation information of the region (e.g., no-parking areas, one-way roads, roads for “buses only”, and so on) and information of unspecified destinations inside the region (e.g., various stores and companies), when entering the region for reasons for a trip or an appointment to see someone, or others.

Of course, if the client carries a terminal capable of being connected to the Internet, the client can obtain required information through searching the desired information using a radio Internet network (or mobile communication network). However, it cannot provide information of the special region, particularly, information of unspecified region where the client visits because it serves only information of the whole area.

Moreover, conventionally, information provided to the client under the Intranet or Internet environment is transmitted to the client's PC without consideration of the present position of the client. Therefore, the client must select a method for obtaining information whenever visiting the region for a long time for reasons for a business trip or others. Thus, the client cannot obtain urgent information just at the right moment.

### SUMMARY OF THE INVENTION

Accordingly, the present invention is directed to an informative service method substantially obviates one or more problems due to limitations and disadvantages of the related art.

An object of the present invention is to provide an informative service method capable of providing information of a region according to change of a client's position through a mobile terminal such as a mobile phone in a real time.

Another object of the present invention is to provide an informative service method capable of recommending desired stores based on the client's position or other clients' evaluation when the client wants to visit a special store within a specified region and capable of displaying the recommendation on the client's mobile phone according to display conditions of the mobile phone.

A further object of the present invention is to provide an informative service method capable of providing a preferential information service according to the distance from the client's position and the passage of time in the client's position on the basis of position information registered by the client.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as an embodiment and broadly described herein, an informative service system includes a local CP(Contents Provider) network having a prescribed service supply range of each region, receiving at least one of information of various stores, companies, real estates and so on in the region, information effective only in the corresponding region and other information requested by a client, the local CP network transmitting the received information to a terminal of the client who is located within the region; and a position confirmation network continuously confirming the client's position through the client's own terminal and providing the confirmed position information of the client to the local CP network.

In the aspect of the present invention, as a first embodiment, an operating method of an informative service system includes the steps of: continuously confirming the location of a terminal set to receive various services; and collecting special information required for supply of traffic information in a region through a local CP network constructed in the region when it is confirmed through pilot signal transmitted from a client's terminal that the client's terminal enters the region and transmitting the collected information to the client's terminal.

In the aspect of the present invention, as a second embodiment, an operating method of an informative service system includes the steps of: confirming change of information effective only in a special region through a local CP network constructed in the region; obtaining the changed information if information is changed; extracting a target for applying information if information is obtained; and notifying the extracted information to a terminal of the target to apply information.

In the aspect of the present invention, as a third embodiment, an operating method of an informative service system includes the steps of: receiving information of a special condition generated in a store or company located in a special region through a local CP network; confirming pilot signal generated from terminals located in the region; obtaining information of owners of the confirmed terminals; confirming whether or not the obtained information of the owners is applied to the special condition generated in the corresponding region; and providing information of the special condition to the owners' terminal if it is confirmed that the special condition is applied to the owners.

In the aspect of the present invention, as a fourth embodiment an operating method of an operating method of an informative service system for providing requested information if a owner of a terminal entering a special region requests special information within the region through Internet connection using the terminal, the operating method includes the steps of: receiving the requested information through a server network; confirming the present position of the owner of the terminal who requests information; and transmitting data of the requested information to the local CP network constructed in the confirmed location.

In the aspect of the present invention, as a fifth embodiment, an operating method of an operating method of an informative service system, if a client who enters a special region requests special information of the region using a terminal of the client, the method includes the steps of: transmitting the request of information received from the client to a local CP network through a network linking device of a base station receiving signal transmitted from the client's terminal, the local CP network having much information of the region where the client is located; searching the requested information from information stored in the local CP network receiving the request of information; and transmitting the searched information to the client's terminal.

In another aspect of the present invention, an informative service system includes a database having information of stores located in each region; a receiving part for receiving a request of information of the stores by classification from a terminal of a client; a position confirming part for confirming the position of the client's terminal which receives the request of information through the receiving part; an information obtaining part for searching the database based on the contents received through the receiving part and position information of the client and obtaining information of the stores within a prescribed range where the client is located; a classifying part for classifying the obtained information according to preferred display precedence; and transmission part for transmitting the classified information to the client's terminal.

In the aspect of the present invention, an operating method of an informative service system includes the steps of: confirming the position of a client if the client requests information of stores for providing special service according to specified classification; obtaining information of the stores, which are located in the region where the client is located, according to the specified classification; classifying the stores according to display precedence based on a preferred order set using the obtained information; and transmitting the classified information to the client's terminal.

In a further aspect of the present invention, an information service system includes: a database storing information of a standard location registered by the client, information of critical value of a difference in time and space from the standard location and information related with services provided according to the difference in time and space; position confirming means for grasping the present position of the client; time measuring means for counting time exceeding the critical value from the standard location registered by the client; information obtaining means for obtaining information of services set according to the difference in time and space confirmed by the position confirming means and the time measuring means; and information transmitting means for transmitting the obtained information to a terminal of a client.

In the aspect of the present invention, an operating method of an informative service system includes the steps of: registering a standard location by a client; continuously confirming the present position of the client; confirming a difference in time and space between the confirmed present position of the client and an initially registered standard location; and performing service set according to exceeded difference if the confirmed difference in time and space exceeds a critical value of the set difference in time and space.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a view of structure of an informative service system according to a first preferred embodiment of the present invention;

FIG. 2 illustrates a view of a service providing process of the informative service system according to the first embodiment of the present invention;

FIG. 3 illustrates a flow chart of an operation process of the informative service system according to the first embodiment of the present invention;

FIG. 4 illustrates a view of a service providing process of an informative service system according to a second preferred embodiment of the present invention;

FIG. 5 illustrates a flow chart of an operation process of the informative service system according to the second embodiment of the present invention;

FIG. 6 illustrates a flow chart of another example of the process of FIG. 5;

FIG. 7 illustrates a view of an operation process of an informative service system according to a third preferred embodiment of the present invention;

FIG. 8 illustrates a flow chart of a service process of the informative service system according to the third embodiment of the present invention;

FIG. 9 illustrates a flow chart of another example of the process of FIG. 8;

FIG. 10 illustrates a flow chart of a service process of an informative service system according to a fourth preferred embodiment of the present invention;

FIG. 11 illustrates a view of an operation process of the informative service system according to the fourth embodiment of the present invention;

FIG. 12 illustrates a view of a structure of an informative service system according to a fifth preferred embodiment of the present invention;

FIGS. 13 through 15 illustrate flow charts of each operation process of the informative service system according to the fifth embodiment of the present invention;

FIGS. 16 and 17 illustrate flow charts of examples of a process for evaluation of the operation processes according to the fifth embodiment;

FIG. 18 illustrates a view of a structure of an informative service system according to a sixth preferred embodiment of the present invention;

FIG. 19 illustrates a flow chart of an operation process of the informative service system according to the sixth embodiment of the present invention; and

FIG. 20 illustrates a flow chart of another example of the process of FIG. 19.

### DETAILED DESCRIPTION OF THE PREFERRED EMBODIMENT

Reference will now be made in detail to the preferred embodiments of the present invention, examples of which are illustrated in the accompanying drawings.

First, a first preferred embodiment of the present invention is to provide information of a certain region according to change of a client's position through the client's mobile phone in a real time and to provide the above information through a local CP(Contents Provider) network, which is designated to provide services only of the corresponding region.

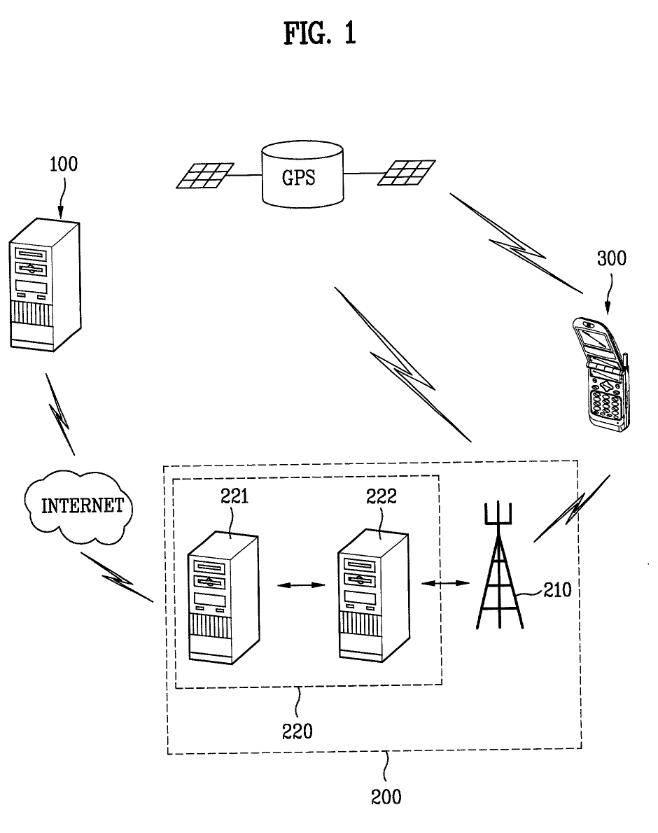

FIG. 1 illustrates a structure of the first preferred embodiment of an informative service system according to the present invention.

That is, the first embodiment of the informative service system according to the present invention includes: a local CP(Contents Provider) network 100 providing various local information services through various communication networks by designating only a specified region as a target area of online service; and a position confirmation network 200 for continuously confirming the position of the client who requests information service and providing service to the local CP network 100.

At this time, information provided through the local CP network 100 includes not only basic information of the region such as various stores, companies, buildings or others located in the region but also at least one of information effective only in the region and information requested by the client.

The position confirmation network 200 includes base stations 210 of various mobile communication service providers for receiving pilot signal transmitted from a terminal 300 of the client and confirming the present position of the client and a network linking device 220 for linking a mobile communication network with an Internet network.

At this time, as additional linking means for confirming the position of the client's terminal, a typical GPS(Global Positioning System) and a location gateway are used. The network linking device 220 is linked with a typical switching system 221 of the mobile communication provider and a gatewayserver 222.

The terminal 300 of the client must be capable of connecting with the Internet during movement, receiving requests of information through the Internet, receiving and sending various messages and displaying various images. For the terminal 300, there may be mobile phones, CNSs(Car Navigation Systems), mobile computers, CDMAs, PDAs, WEB TVs and the likes. In the present invention, the mobile phone is used as the terminal 300.

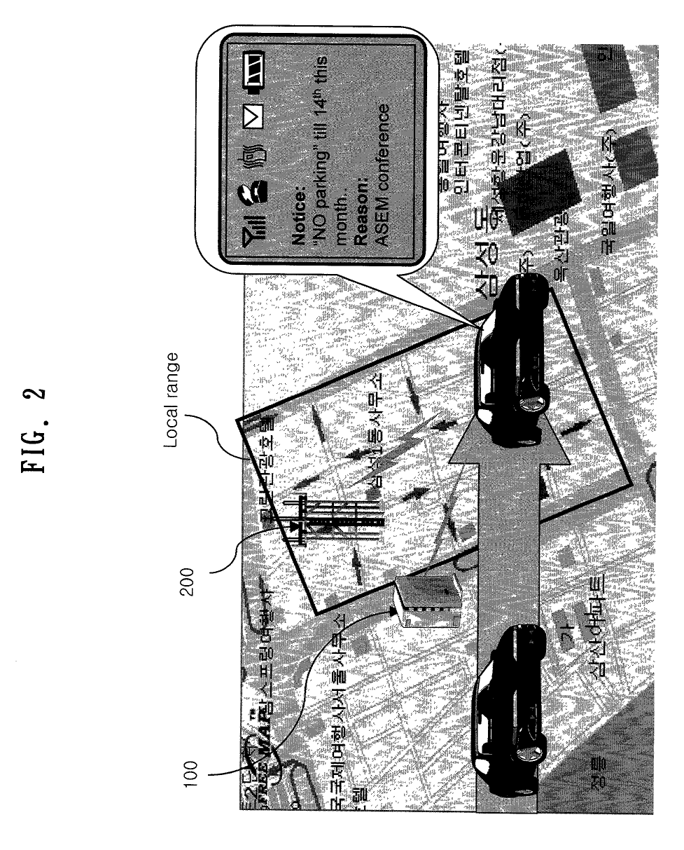

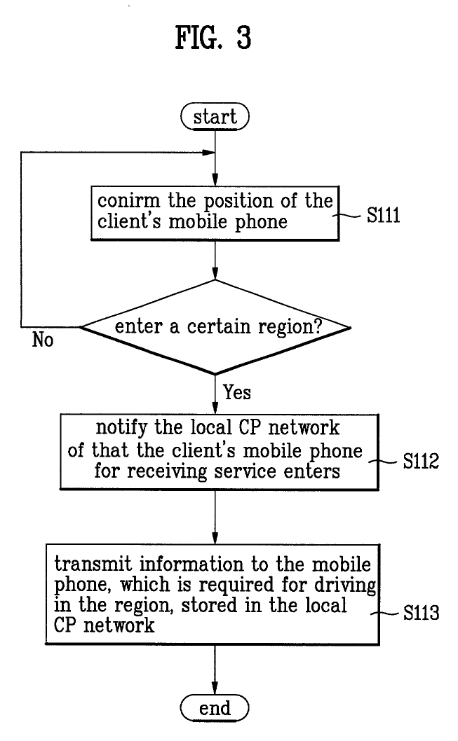

Hereinafter, referring to FIGS. 2 and 3, a service method using an informative service system having the above structure will be described in more detail.

At this time, it is assumed that the client is registered to obtain information of various traffic conditions occurring in the region through the informative service system of the present invention and that information of the client's mobile phone is registered in the service system. However, it is appreciated that the client may use the corresponding service without the registration.

First, the position confirmation network 200 of the informative service system confirms pilot signal generated from the mobile phone 300 of the client and continuously tracks the present position of the client (S111).

In this step, if the client enters a certain region using the client's car, the position confirmation network 200 transmits information of the client and information of the requested service registered by the client to the local CP network 100 of the region (S112).

The local CP network 200 collects information that is needed for car driving in the region and transmits the collected information to the client's mobile phone 300 (S113).

At this time, information needed for the car driving may be obtained through a network, which a traffic service provider providing traffic information manages. Alternatively, the local CP network 100 may serve as a network of the traffic service provider.

A process for transmitting the corresponding information to the client's mobile phone 300 is as follows. The local CP network 100 converts the collected information into data capable of being displayed on the mobile phone 300 and transmits the converted data to an IP(Internet Protocol) of the client's mobile phone 300.

Information needed for the car driving within the corresponding region means one of information of “no passing” zone effective only in the corresponding region, information of the current traffic condition within the corresponding region, information of limitation conditions of each road within the corresponding region and information of the current condition of each road.

For example, information needed for the car driving may be information of traffic rule (e.g., Korean traffic rule that the driver cannot drive his own car if the final number of a license plate is the same as the day that the client drives his own car), information of car passing limitation by each road (including bridge), information of passing control condition due to accident, event or road construction, information of no-parking area of the corresponding region, information of one-way traffic roads, information of restricted driving speed, and so on.

The above information may be simply provided only in character using a SMS(Short Message Service), but it is preferable to use a mobile data communication having a map of the corresponding position for providing information in more detail.

The service method according to the first preferred embodiment may be effectively used when the client who lives in a city wants to visit other cities using the client's own car.

Meanwhile, the informative service system according to the first preferred embodiment is not restricted to provide the above traffic information and may be used more widely.

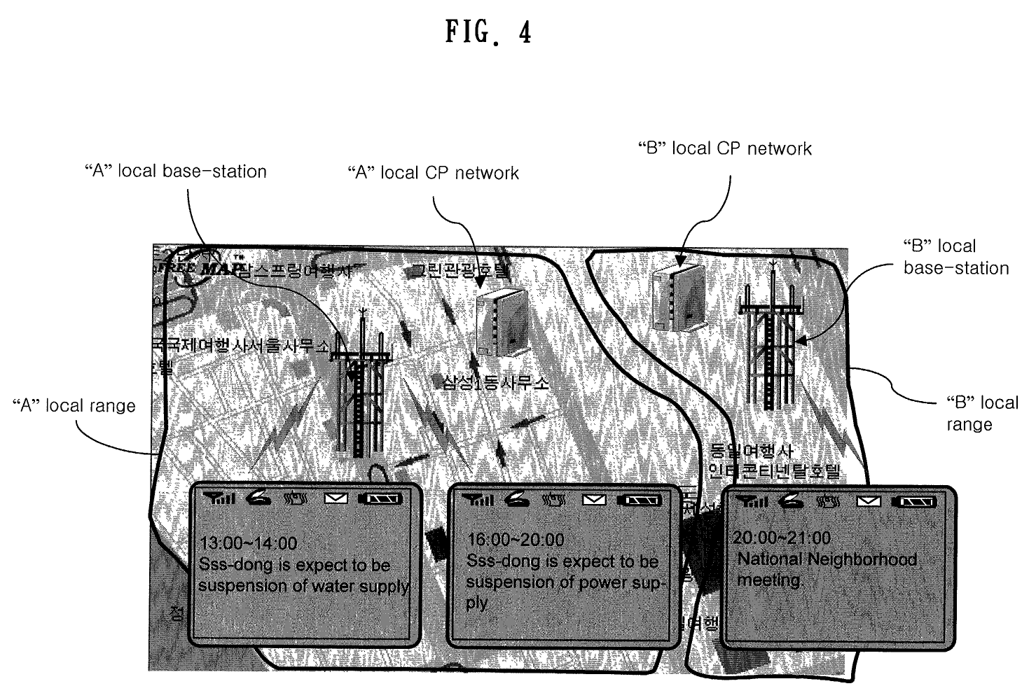

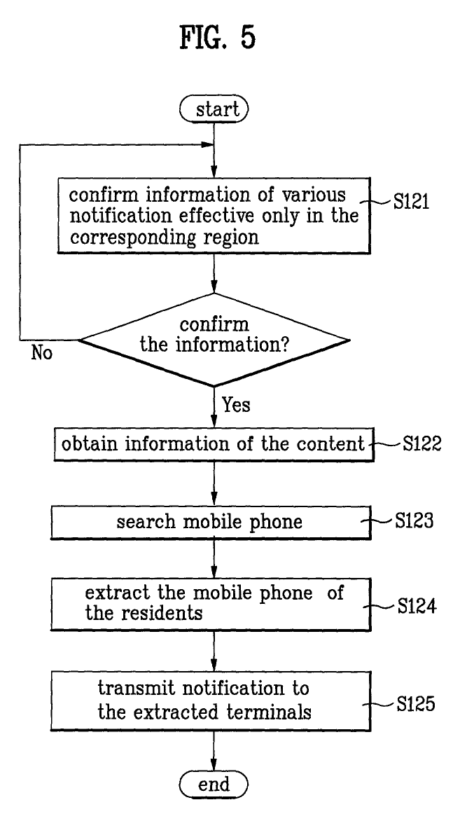

A second preferred embodiment of the present invention provides a service method to notify information necessary for only local residents, who live in the specific region, using the informative service system according to the first preferred embodiment. Referring to FIGS. 4 and 5, the second preferred embodiment will be described in more detail.

First, the local CP network 100 continuously confirms information of various conditions occurring only in the region (S121).

At this time, the various conditions may be one of stop of the water supply, suspension of power supply, a neighborhood meeting, civil defense, various disasters occurring only in the region, or notifications provided from a government office to the local residents.

Because the above information is treated by the government office located in the region, it is preferable that the local CP network 100 is linked to a network of the government office to easily provide information. Alternatively, the local CP network 100 may be the network managed by the government office.

During the continuous confirmation step, if one of the various conditions is generated, the local CP network 100 obtains information of the generated condition (S122) and confirms information of an owner of each mobile phone (mobile communication terminal) 300 located in the region (S123).

At this time, the confirmation of the owner of each mobile phone 300 is performed through the position confirmation network 200. The position confirmation network 200 extracts only information of the mobile phone 300, which the local residents have (S124).

That is, the position confirmation network 200 confirms the owner of the mobile phone 300 using information of the mobile phone 300 located in the region and extracts only the local residents, who live in the region and the owner of the confirmed mobile phone 300.

If the position confirmation network 200 completes the extract of the local residents, the local CP network 100 transmits and notifies specified information occurring in the region to the mobile phones 300 of the local residents (S125).

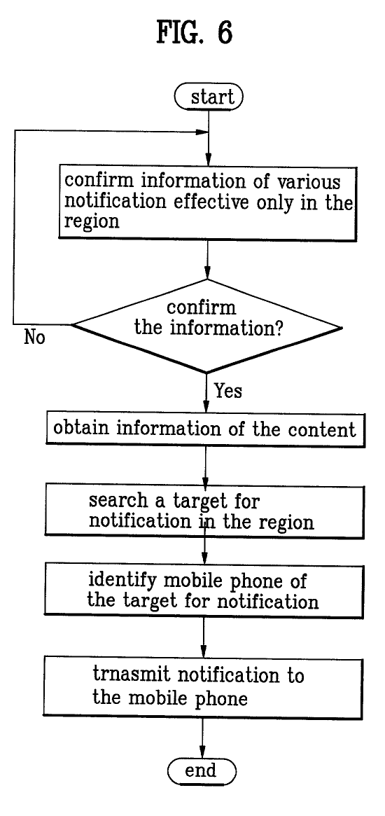

Of course, the local CP network 100 may not only extract the local residents of the region and transmit the specified information to the mobile phones 300 of the local residents but also transmit the specified information to the mobile phones of the local residents stored in the local CP network 100 as data after receiving information of the mobile phones of the local residents (information receivers) and storing information as data in the local CP network 100, like a process shown in FIG. 6.

Finally, the service method according to the second preferred embodiment can easily notify desired information to the local residents through the local CP network.

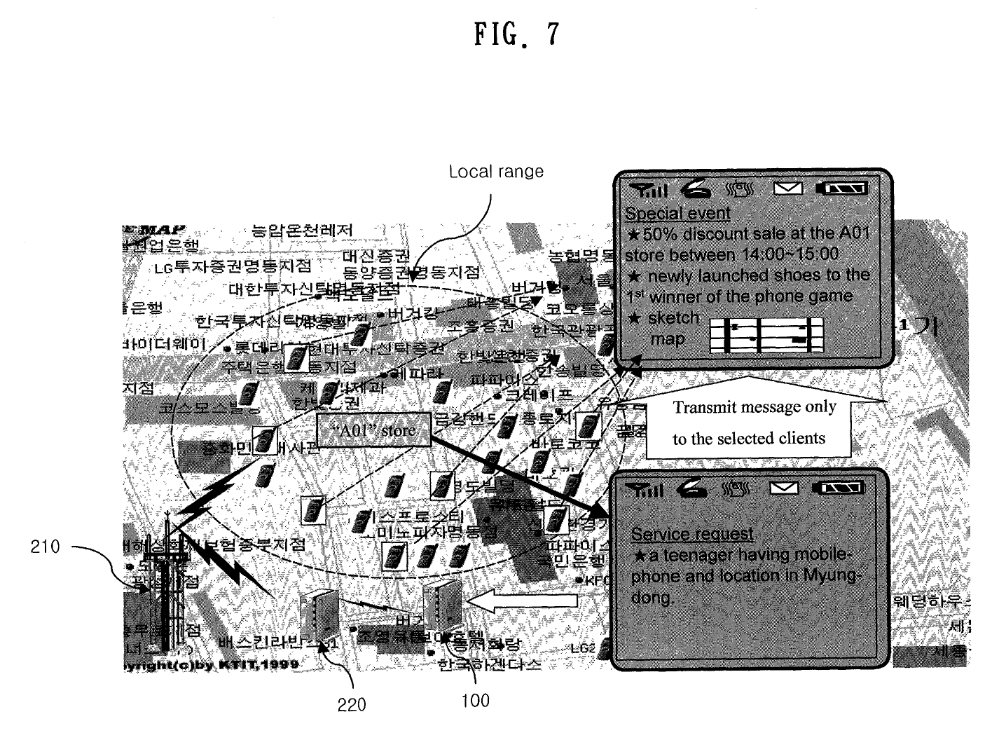

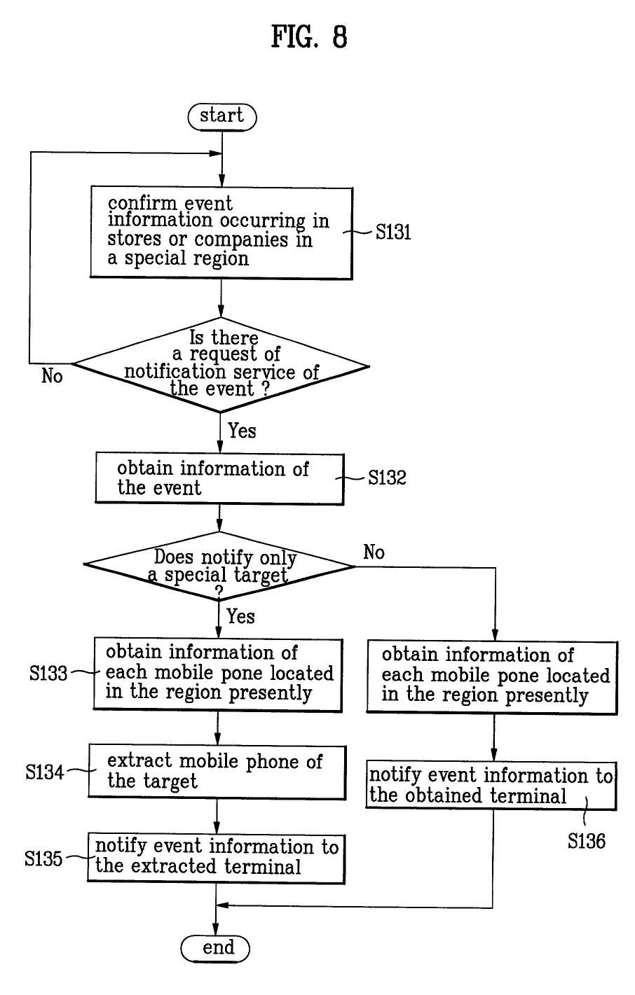

A third preferred embodiment according to the present invention is another service method using the structure of the informative service system of the first embodiment. The third preferred embodiment provides a method that the local CP network 100 receives information of special conditions of stores or companies located in the region and notifies the above information only to a terminal of a special owner of owners of terminals located in the corresponding region. Referring to FIGS. 7 and 8, the service method will be described in more detail.

First, the local CP network 100 continuously confirms information of special conditions occurring in the stores or companies located in the corresponding region (S131).

The special conditions may be events progressed in the stores or companies located within the range of service provided through the local CP network 100.

If one of the stores or companies requests a service for the event to the local CP network 100, the local CP network 100 receives the request of service (S132).

At this time, the contents transmitted from the stores or companies to the local CP network may be contents of event, information of a target of event.

For example, if an A01 store wants to perform event for providing a surprise discount (for example, 50% discount of the whole items performed in the A01 store located in Myongdong (in Seoul, Korea) from 2 o'clock to 3 o'clock Friday) or providing premiums, the A01 store can transmit information of location and name of the A01 store, contents of event, target of event to the local CP network 100.

In the above process, the local CP network 100 receives the service requested by the A01 store and obtains information of the owners of the mobile communication terminals located in the region, where the event is performed, using the received information (S133).

It may be performed through the position confirmation network or performed using a position confirmation service through agreement with communication providers.

The local CP network extracts owners of the mobile communication terminals, who correspond to the target of the event performed in the A01 store, based on information of the owners of the obtained mobile communication terminals (S134).

For example, if the target of the event performed in the A01 store is women in teens and twenties, the local CP network 100 extracts and sorts only the mobile communication terminals of owners having the corresponding age and sex of the obtained owner information of the mobile communication terminals through the identification of the owners of the mobile communication terminals.

After that, the local CP network 100 notifies information of the target and the contents of the event performed in the A01 store, location of the A01 store, the name of the A01 store and so on and finishes the service. (S135).

If the event is all clients-oriented event, the local CP network 100 notifies information of the event to all confirmed mobile communication terminals located in the region (S136).

The location of the store may be displayed in a simple text. However, to increase a rate of participation in the event, it is preferable that the store may transmit map data for showing the present position of the target of the event and the location of the corresponding store and the local CP network 100 displays map data on the terminals.

However, the third preferred embodiment is not restricted by the above service method.

That is, to increase a response rate of the event, the owners of the mobile communication terminals, who receive the notification of the event, may directly participate in the event through the own terminal.

Therefore, the service method provides not only an advertising method for notifying information of sale or discount but also a method for performing an automatic lottery of premiums by inducing the owner of the terminal to acknowledge or recall the advertisement.

Such method is good for increasing the rate of participation in the event if department stores or other stores perform events.

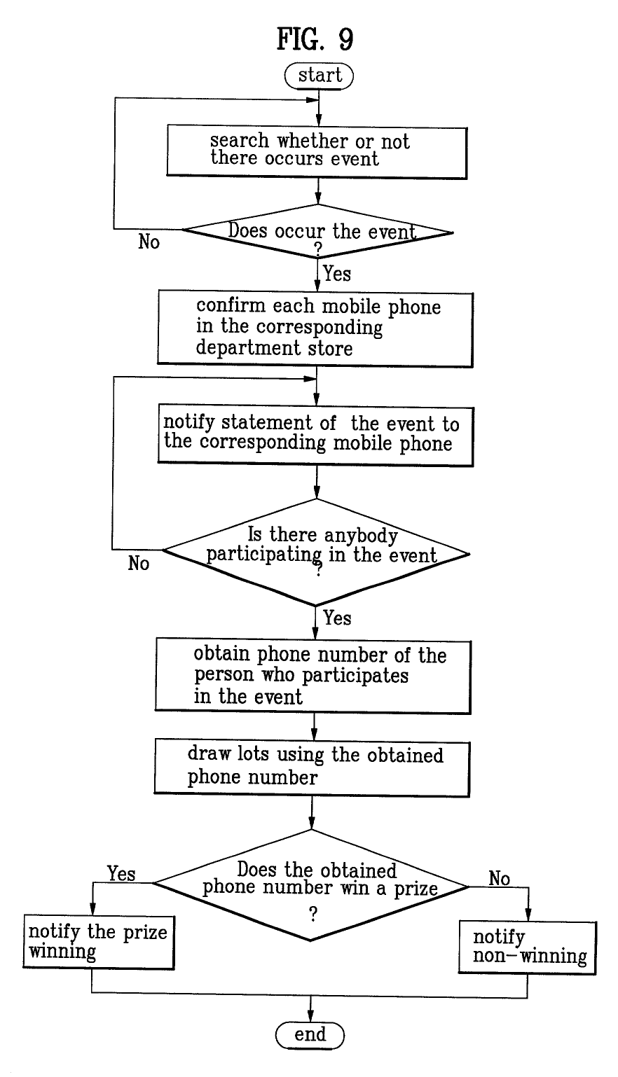

For example, like a flow chart shown in FIG. 9, if the owners of the terminals respond to the contents of the event performed in the department store during a prescribed period of time, the local CP network notifies the contents of the lottery immediately by holding the lottery of the respondent, thereby inducing the client's positive participation of the event.

For the method for performing the automatic lottery of premiums, in consideration that the phone number of the respondent of the event may be obtained through a recall function of the mobile communication terminal, the lottery number is given to each obtained phone number and the given lottery number is compared with set winning numbers (or numbers drawn lots at random), and thus the respondent can confirm immediately whether or not the respondent wins a prize.

After all, the third embodiment can attract the clients to the specified store or company, which is located in the region, through advertisement such as the event by notifying to the owners of the terminals located in the region.

That is, although clients who are in other regions receive information of the event performed in the specified store, it is rare for them to directly visit the store. Therefore, the present invention can help attract clients to the store by providing profits of participation in advertisement or event for only the clients who are in the region where the specified store is located.

Meanwhile, a fourth preferred embodiment according to the present invention is to provide desired information through the local CP network 100 located in a location, where the client is, when the client who enters a non-residential region not the residential region wants to know special information of the non-residential region.

For this, the informative service system is linked with the local CP network 100 and the position confirmation network 200 of each region. The informative service system further includes a server network 400 for receiving information requested by the client and transmitting the requested information to the local CP network 100, which is located in the region where the client is located.

The reason is that a conventional network providing service through an Internet network cannot provides an exact service of all information, which the client requests, because requiring a vast storage space, manpower and material resources for storing all detailed information and that the conventional network requires very complicated process for connecting to the corresponding network, selecting region providing desired information, inputting keyword of the desired information provided in the region, selecting detailed statement of the desired information and others.

However, in the present invention, the server network 400 only serves as a mediator, and the local CP network 100 provides and manages information practically.

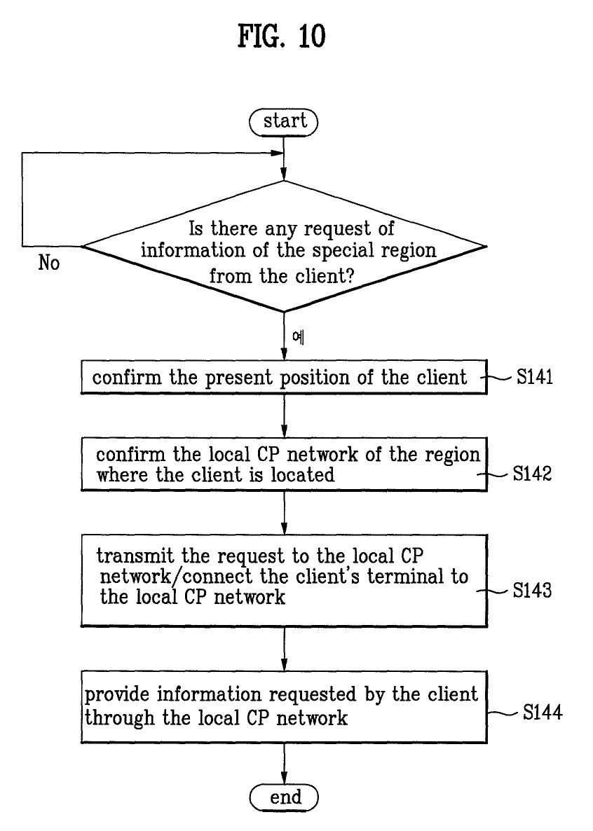

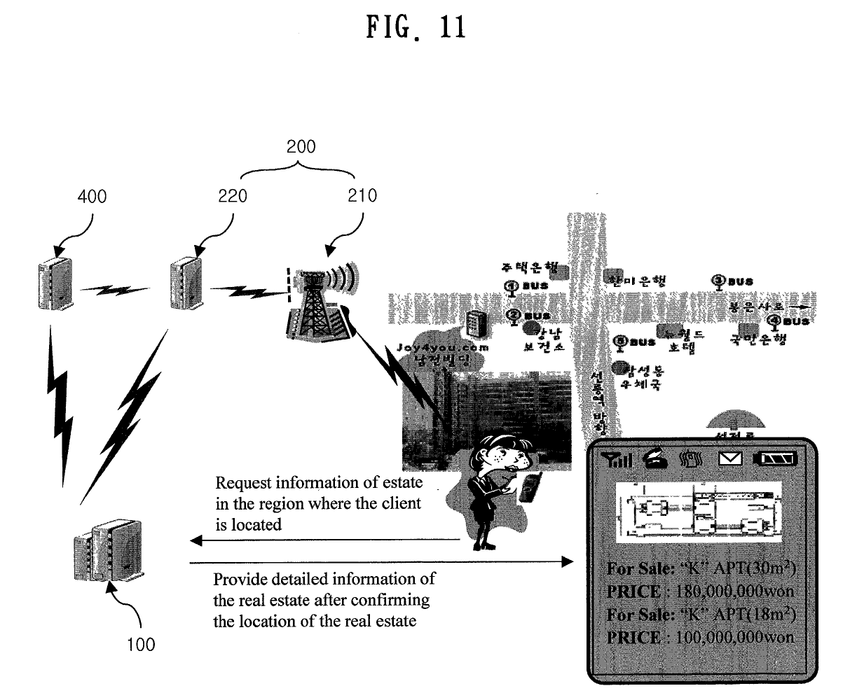

Hereinafter, referring to FIGS. 10 and 11, the service method according to the fourth embodiment will be described in more detail.

First, if the client, who does not live in the region and not exactly know information of the region, wants to know specified information of the region during passing the region, the client connects to the Internet network using the client's own mobile communication terminal 300.

If the client inputs desired information to the server network 400 providing the corresponding service, the server network 400 receives information and confirms the region where the client is located (S141).

The position confirmation may be performed through a method confirming a local base station 210 to which the client is connected through a channel connected with the client's mobile communication terminal 300.

If the position of the client is confirmed, the local CP network 100 constructed in the confirmed region is searched (S142) and the requested information is transmitted to the local CP network 100, and at the same time, the terminal 300 of the client who requests the corresponding information is connected to the local CP network 100 (S143).

After that, the local CP network 100 searches and obtains the requested information and notifies information to the client's terminal (S144).

Therefore, the client can easily obtain the requested information.

As shown in FIG. 11, if the client requests special real estate located in the specified region to the server network 400 when passing the region, the server network 400 confirms the present position of the client through the position confirmation network 200 and transmits the requested information and information of the client's mobile communication terminal 300 to the local CP network 100 located in the confirmed region.

The local CP network 100 receiving information transmits information of real estate for sale requested by the client and information of structure of real estate to the client's mobile communication terminal 300.

Through the structure and operation method of the informative service system according to the fourth preferred embodiment of the present invention, the client can obtain satisfactory service by obtaining exact and desired information, and the server network can minimize load for providing various information and obtain profits in management.

Meanwhile, a fifth preferred embodiment is to provide a service method that provides recommendation of each store to the client's mobile communication terminal and displays only preferred necessary information in order according to a display condition of the mobile communication terminal.

The structure of the fifth embodiment is similar to that of the fourth embodiment.

That is, the informative service system according to the fifth embodiment includes a local CP network 100 for managing supply of information of a specified region, a server network 400 for receiving request of service from each client and transmitting the request to the corresponding local CP network 100, and a position confirmation network 200 for confirming the position of each client.

At this time, the local CP network 100 includes a database 110 for storing information of each store located in the specified region, an information obtaining part 120 for continuously updating information of each store located in the region, a classifying part 130 for classifying the obtained information according to preferred order for display, and a transmission part 140 for transmitting the classified information to the corresponding client's mobile communication terminal 300. It is a different point from the fourth embodiment.

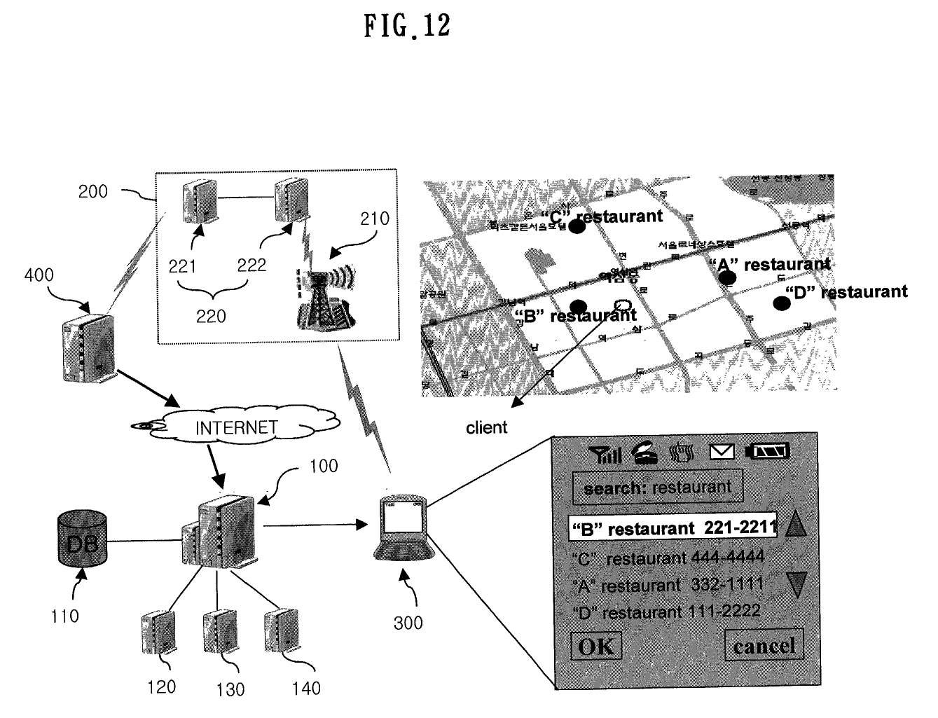

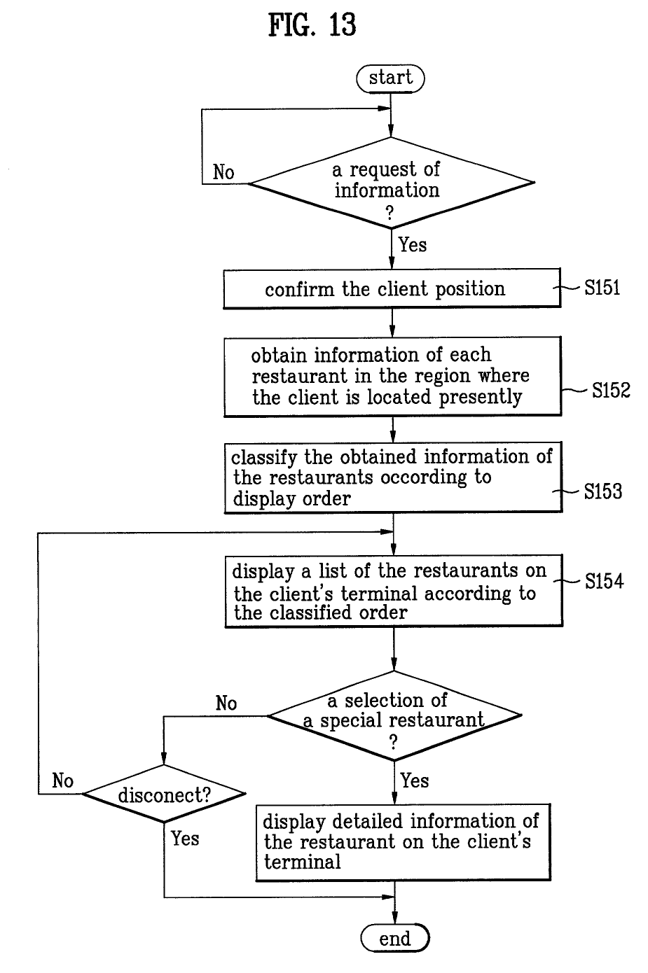

Hereinafter, referring to FIGS. 12 and 13, a service method according to the fifth embodiment will be described in more detail.

In this embodiment, a restaurant is described as an example, but it is not restricted to the restaurant and may applied to all stores such as department stores, or other stores for selling articles or providing services.

First, if the client who is in the specified region requests information of the restaurant located in the region using the client's own terminal 300, the request is transmitted to the server network 400.

The server network 400 receiving the request of information confirms the present position of the client through the position confirmation network 200 (S151).

After that, the server network 400 transmits the client's request of information to the local CP network 100 constructed in the confirmed region and connects the client's mobile communication terminal 300 to the Internet network operated by the local CP network 100.

The information obtaining part 120 of the local CP network 100 searches information stored in the database 110 based on the confirmed position information of the client and obtains information of each store located in a prescribed range where the client is located (S152).

The obtained information is classified according to the preferred display precedence through the information classifying part 130 (S153).

At this time, the preferred display precedence may be display precedence according to neighboring order from the corresponding client's position, display precedence according to the visit number of other clients, display precedence according to evaluate grades by each store, display precedence according to the number of search, or others.

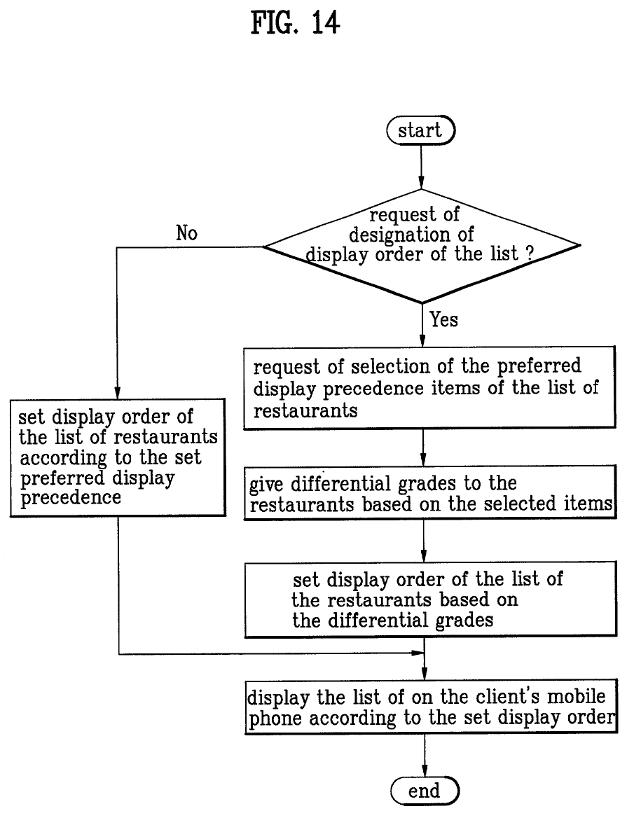

In case that the client wants to directly designate the display precedence of display items, as shown in FIG. 14, if the client requests the preferred display precedence, the informative service system gives differential grades to the display items based on the selected items and displays the list of the restaurants.

For example, in case that the client prefers the restaurant providing tasty foods, if the client inputs a keyword of “food taste”, the classifying part 130 of the local CP network 100 determines display precedence of the restaurants according to the precedence evaluated as the restaurant providing tasty foods, and displays the list of the corresponding restaurant on a screen of the mobile communication terminal 300 of the corresponding client according to the display precedence.

Of course, the keyword may be one word, but it is preferable to set as at least two or more words.

The reason is to search the optimal restaurant, which the client requires, through multiple conditions.

Furthermore, if the keyword for determining the display precedence is input in two or more words, the classifying part 130 gives virtual differential grades according to the order of the input words and determines the display order of the desired restaurant through the total sum of the given grades.

For example, if the client wants to search the restaurant which provides tasty foods and is located in the nearest location of the client's position, the client inputs retrieval conditions (keywords) of the food taste and the nearest location through the client's own terminal 300.

Then, the classifying part 130 of the local CP network searches restaurants by the grades of the food taste referring to position information of the corresponding client from the position confirmation network 200 and information of each restaurant located in the corresponding region, which are stored in the database 110.

After that, the classifying part 130 gives virtual differential grades to the searched restaurants according to the precedence of food taste.

Additionally, in the same way as the above method, the classifying part 130 searches the restaurants, which is nearer to the client's position, by precedence of distance and gives virtual differential grades to the searched restaurants.

If the above process is finished, the classifying part designates again the precedence by grades to the restaurants to which the differential grades are given.

At this time, it is preferable to give the virtual grades differentially.

That is, by providing a prescribed additional grades(virtual grades) to the evaluation grades of food taste of the restaurants, there is a proper difference from the nearer distance grades to the client's position. Therefore, even though the restaurant is nearer to the client's position than others, if the food taste is ill-tasting, the restaurant is located to a rear portion in the display precedence.

However, the present invention is not restricted to the display order set through the virtual differential grades, and it is also possible to set the display order of the restaurants located within a prescribed range (for example, within the radius range of about 50 M) from the client's present position according to more excellent food taste.

Meanwhile, it is preferable that not the local CP network 100 but the clients give grades to the food taste of the restaurants.

That is, through the direct visit or the recommendation of the clients to the corresponding restaurants or through the inquiry number of the clients to the corresponding restaurants, grades are given to the restaurants, and thereby a fair evaluation of the restaurants is possible and the clients can trust the information.

However, at this time, one person may continuously recommend a certain restaurant with the object of advertising the restaurant. Therefore, it is preferable to prevent reevaluation of the clients by storing information of the clients (generally, information of the client's mobile communication terminal), who has previously evaluated the corresponding restaurant, with information of the corresponding restaurant in the database 110.

After all, the list of the restaurants designated in the display order through the above process is transmitted to the client's terminal 300 through the transmitting part 140 and then displayed (S154).

To make smoother information retrieval possible, brief information(for example, one of information of phone number, recommended number, searched number and taste level of foods) of the restaurants besides the list of the restaurants may be displayed on the display screen.

Addresses having detailed information of each restaurant are linked to the list of the restaurants to display more detailed information of the corresponding restaurant, if the client selects one of the listed restaurants in the above state.

The detailed information may be introduce, main menu and position of the restaurant. It is preferable to display a map of the restaurant on the terminal screen to exactly show position information of the restaurant.

At this time, the map includes the present position point of the client, the position point of the corresponding restaurant and a path to guide the client to the corresponding restaurant.

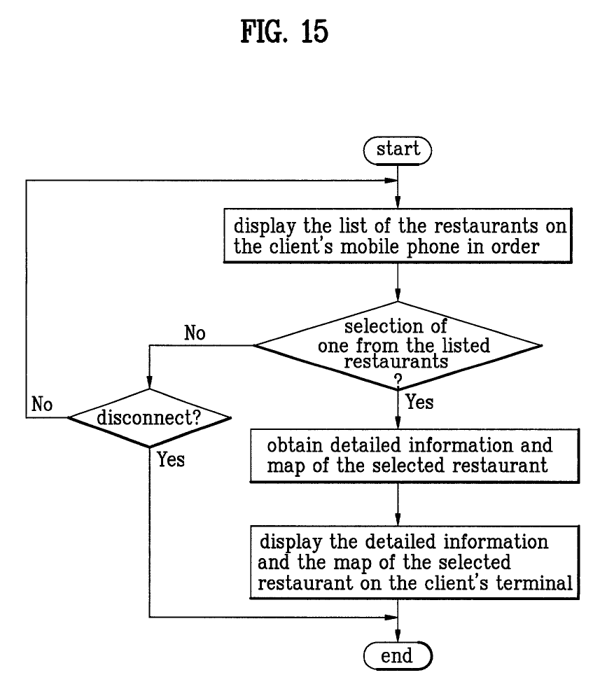

FIG. 15 illustrates a brief flow chart showing the above process.

Additionally, for the above recommendation of the restaurant, the present invention provides a method for fairly evaluating the restaurants. The process for giving evaluation grades will be described in more detail as follows.

First, the grading is largely divided into two methods. One is a method for giving grades when the client selects one of the listed restaurants displayed on the terminal screen. The other is a method for giving grades by giving the impressions of the food taste after directly visiting the corresponding restaurant.

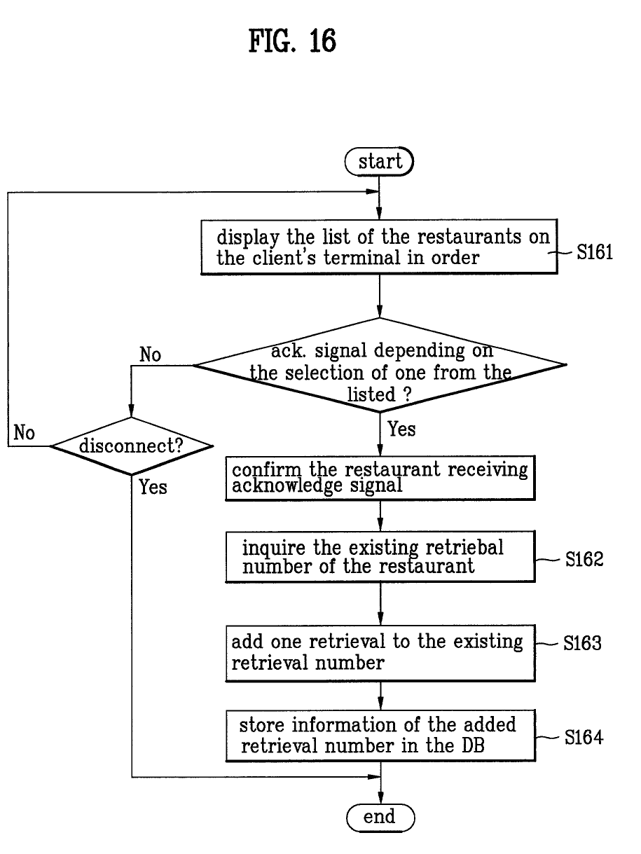

At this time, referring to FIG. 16, a process for allowing the client to evaluate the restaurant through the client's terminal will be described as follows.

First, the list of the restaurants determined in the display precedence is displayed on the client's mobile communication terminal 300 through the transmitting part 140 and the client selects one of the listed restaurants (S161).

In this step, acknowledge signal generated by the client's selection of one of the restaurants is transmitted to the local CP network 100 after passing the mobile communication network and the Internet network in order.

The local CP network 100 grasps the number of the existing inquiry and retrieval of the selected restaurant after reading acknowledge signal (S162).

After that, the local CP network 100 adds the client's inquiry number and retrieval of the restaurant to the existing inquiry number and retrieval (S163), and stores information of the added number of the inquiry and retrieval into the database 110 (S164). The stored number of the inquiry and retrieval is used for giving grades when recommending the restaurant later.

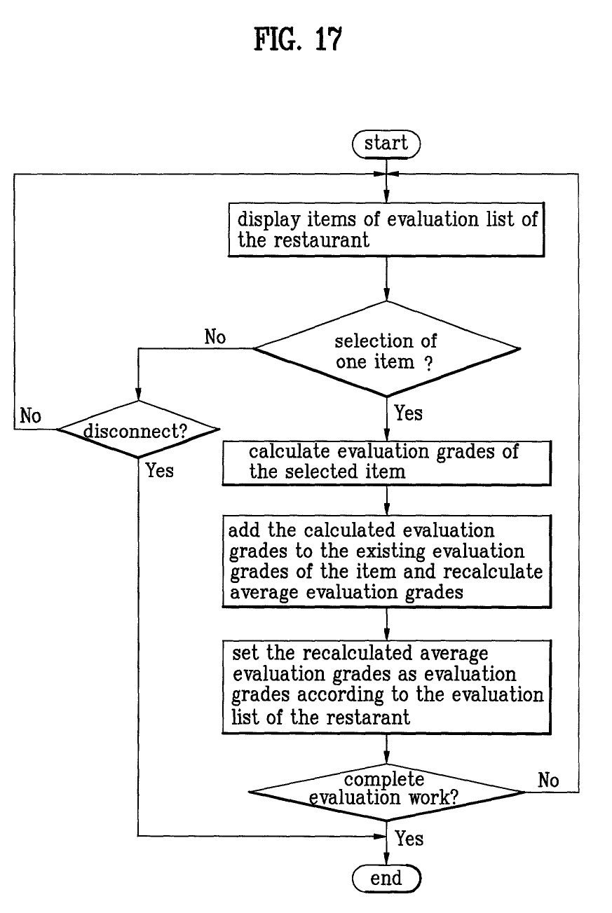

FIG. 17 illustrates a flow chart of a method for allowing the client to give grades to the restaurant by giving impressions of the corresponding restaurant after directly visiting the restaurant.

That is, the informative service system induces the client to connect to web-sites for evaluation managed by the local CP network and requests the client to evaluate the corresponding restaurant.

At this time, evaluated items are differential evaluation items of the corresponding restaurant.

For example, the evaluation items of the evaluation list of “food taste” or “kindness” may be “very good”, “a little better”, “normal” and “extremely bad”, and the items are set to have differential grades.

Therefore, the client directly evaluates the corresponding list by selecting one of the evaluation items displayed on the client's terminal screen. The local CP network 100 recalculates the evaluated grades of the corresponding restaurant according to the client's evaluation and updates the evaluation of the restaurant.

At this time, the process for recalculating the evaluation of the restaurant includes the steps of: calculating evaluation grades of the selected item if the client selects one of the evaluation items; and recalculating average evaluation grades of all clients including the calculated grades and the existing evaluation grades of the corresponding evaluation list.

However, the present invention is not restricted to the methods that the client selects one of the displayed restaurants on the client's terminal and gives grades to the restaurant or that the client directly visits the corresponding restaurant and gives grades by giving impressions of the restaurant. By combining the two methods, the present invention can perform more fair evaluation and recommendation of each restaurant.

Meanwhile, a sixth preferred embodiment of the present invention provides a service method for providing special informative service according to the distance in time and space from the client's position on the basis of position information registered by the client.

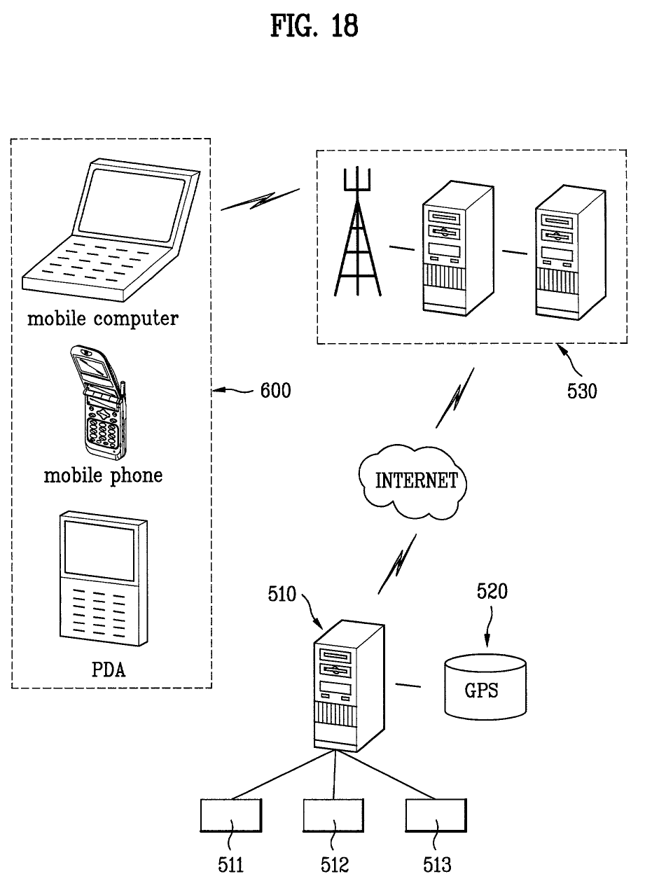

For this, as shown in FIG. 18, the informative service system according to the sixth preferred embodiment of the present invention includes a service supply server 510, a database 520 and a position confirmation network 530 and they are linked with one another.

At this time, the service supply server 510 includes: time measuring means 511 serving to count time exceeding a set critical value from a standard location registered by the client; information obtaining means 512 for obtaining information of service set according to difference in time and space confirmed by the position confirmation network 530 and the time measuring means 511; and information transmitting means 513 for transmitting the obtained information to a terminal 600 of the corresponding client.

The database 520 serves to store information of the standard location registered by each client, information of the critical value of the difference in time and space, and information related with services provided according to the difference in time and space.

The position confirmation network 530 is constructed in the same way as the above embodiments and serves to confirm the position of each client.

The above means are constructed suitable for environments of a mobile communication system based on various networks.

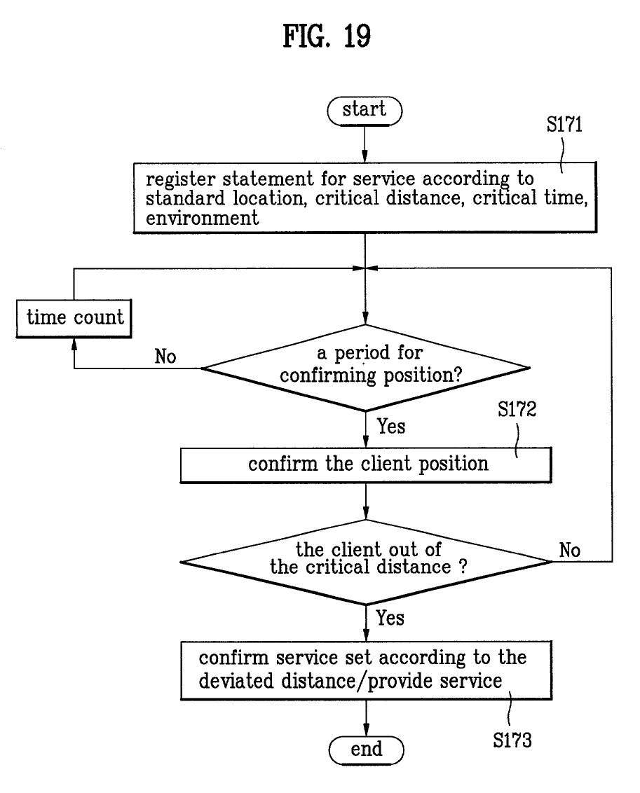

Hereinafter, referring to FIG. 19, a service method using the sixth embodiment of the present invention will be described in more detail.

First, the service supply server 510 receives registration of the standard location, critical distance, critical time and service supply statement according to each condition from the client who requests service. At this time, the registered information is stored in the database with information of the corresponding client (S171).

In this state, the server 510 confirms the present position of the client in link with the position confirmation network 530 (S172) if it is a time period for confirming the set present position, and compares the confirmed information with the registered critical value to determine whether or not the service is performed.

At this time, the critical value is a distance away from the standard location and set by the client.

For example, if the client is a radius of 100 m away from the standard location and wants to receive service, the radius of 100 m becomes the critical distance.

If the client's present position confirmed through the above process is the point, which is not out of the critical distance from the standard location, the above position confirmation process by period is repeatedly performed. If the client's present position confirmed through the above process is the point, which is out of the critical distance from the standard location, the service supply server confirms information of the set items of the service according to the client's position point deviated from the critical distance and supplies service of the set items (S173).

At this time, the set items may be at least one of information of various e-mail addresses transmitted to the client's account after the client is out of the critical distance, information of the restaurant available in the client's present position if it is a mealtime, and information of traffic for helping returning the client to the standard location.

The service method can solve several inconveniences that the client must leave available phone number whenever being away on business or working outside, cannot easily receive e-mail or airmail, cannot easily handle urgent decision cases, and cannot easily find a place for appointment.

That is, the present invention can automatically confirm according to the client's distance from the business place whether the client is away on business or working outside even though being out of the place of business, and can transmit the work, which the client does in the business place, to the client's terminal 600 capable of data communication, thereby increasing the client's a sense of satisfaction.

However, the sixth embodiment of the present invention is not restricted to that the critical value is set based on the distance of special difference.

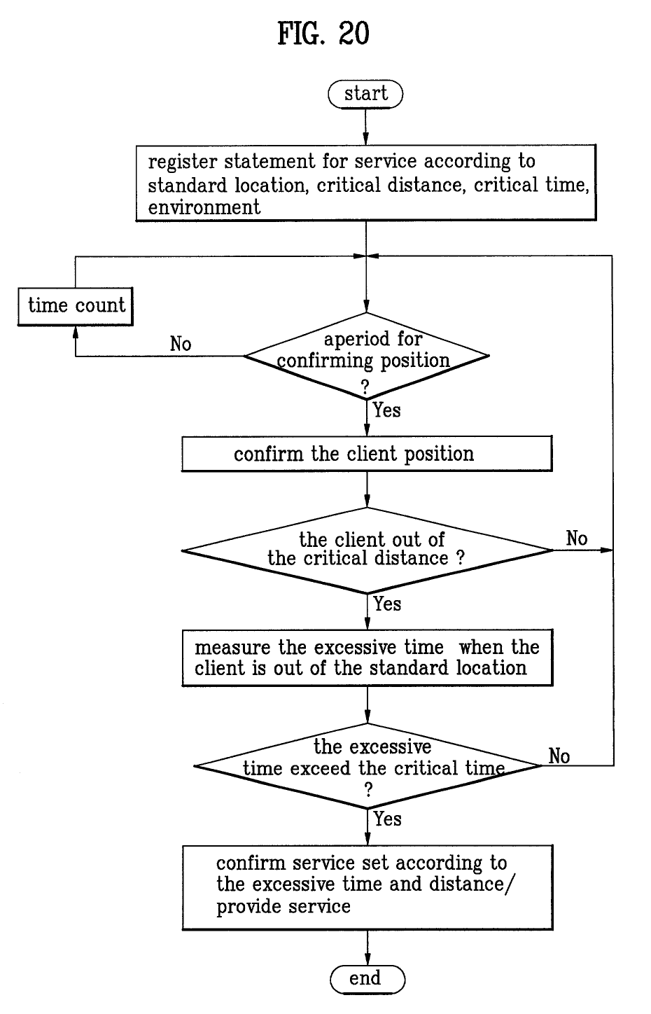

That is, as shown in FIG. 20, the critical value may include critical time, which is a limit value of time maintained in a state that the client is out of the standard location.

In consideration that the client can be out of the critical distance for a while with reason of urgent business, it is preferable to provide the set service if the time that the client is out of the critical distance exceeds the set critical time.

For example, if the client is in Kangnam, Seoul where is the standard location goes to Busan on business, the service supply server 510 determines the client's business trip by confirming through the position confirmation network 530 that the client's position becomes more distant during a prescribed period of time.

That is, in a state that the critical time is set in an hour, if the client who is out of the critical distance does not return to the standard location after an hour and the client's position out of the critical distance becomes more distant from the critical distance, the service supply server 510 determines that the client is away on business.

In this case, the service supply server receives various services (e.g., automatic change of contact methods, change of account for receiving e-mail, change of e-mail receiving method, information of sleeping accommodations, information of restaurants, and so on) registered to provide when the above case from the database and provides the services to the client's terminal.

The service method according to the sixth embodiment of the present invention may be set to confirm how long the client who is out of the standard location stays at the location for visit and provide the special information services. In the present invention, as the process can be easily utilized through the sixth embodiment, it will be omitted.

As described above, the informative service system and the operating method thereof according to the present invention have the following effects.

First, the present invention can automatically provide information requested by the client to the client's mobile communication terminal such as the mobile phone in a real time through the service supply based on the client's position.

Second, the present invention can provide information according to the display conditions of the mobile phone of the client, thereby increasing a sense of satisfaction.

Third, the present invention can provide special information services according to the distance in time and space from the standard location based on position information registered by the client.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An informative service system comprising:
a local CP(Contents Provider) network having a prescribed service supply range of each region, receiving at least one of information of various stores, companies, real estates and so on in the region, information effective only in the corresponding region and other information requested by a client, the local CP network transmitting the received information to a terminal of the client who is located within the region; and
a position confirmation network continuously confirming the client's position through the client's own terminal and providing the confirmed position information of the client to the local CP network.

2. The informative service system according to claim 1, wherein the position confirmation network includes:
a base station for various mobile communication services, the base station receiving pilot signal transmitted from the client's terminal and confirming the client's present position; and
a network linking device for linking a mobile communication network with an Internet network.

3. The informative service system according to claim 1, further comprising a server network receiving various information requested from the client and transmitting the requested information to the local CP network located in the region where the client is located.

4. The informative service system according to claim 1, wherein the client's terminal is capable of receiving various requests of information through the Internet, receiving various messages and displaying various images.

5. An operating method of an informative service system comprising the steps of:
continuously confirming the location of a terminal set to receive various services; and
collecting special information required for supply of traffic information in a region through a local CP network constructed in the region when it is confirmed through pilot signal transmitted from a client's terminal that the client's terminal enters the region and transmitting the collected information to the client's terminal.

6. The method according to claim 5, wherein the special information is at least one of information effective only in the corresponding region, information of the current traffic conditions in the region, information of each road in the region and information of the current conditions of each road.

7. The method according to claim 6, wherein information of the current traffic conditions in the region is information under a traffic control condition.

8. The method according to claim 6, wherein information of each road is information of driving speed limit, information of no-parking areas, information of one-way traffic and map data of the above information.

9. The method according to claim 6, wherein information of the current traffic conditions is information of road conditions due to road construction in the corresponding region and map data of the above information.

10. An operating method of an informative service system comprising the steps of:
confirming change of information effective only in a special region through a local CP network constructed in the region;
obtaining the changed information if information is changed;
extracting a target for applying information if information is obtained; and
notifying the extracted information to a terminal of the target to apply information.

11. The method according to claim 10, wherein information effective only in a certain region is one of stop of the water supply, suspension of power supply, neighborhood meeting, civil defense, various disasters, and notifications provided from a government office to the local residents.

12. The method according to claim 10, wherein the step of extracting a target for applying information effective only in the special region includes the steps of:
confirming owners of terminals located in the region; and
confirming information of the residential region of the confirmed owners and extracting only residents who live in the corresponding region.

13. The method according to claim 10, further comprising the steps of receiving information of the residents' terminal and storing information into data for extracting the target for applying information effective only in the region.

14. The method according to claim 10, wherein the step of obtaining information effective only in the region through the local CP network includes the steps of:
continuously confirming in a state that the local CP network is connected with a network of the corresponding government office managing the region whether or not there is any notification to provide residents; and
obtaining information if there occurs notification.

15. An operating method of an informative service system comprising the steps of:
receiving information of a special condition generated in a store or company located in a special region through a local CP network;
confirming pilot signal generated from terminals located in the region;
obtaining information of owners of the confirmed terminals;
confirming whether or not the obtained information of the owners is applied to the special condition generated in the corresponding region; and
providing information of the special condition to the owners' terminal if it is confirmed that the special condition is applied to the owners.

16. The method according to claim 15, wherein the step of receiving information of a special condition generated in the special region through a local CP network is performed in such a manner that the local CP network receives information of occurrence of event in the store or company in the region, contents of the event and information of the target for the event.

17. The method according to claim 16, wherein a process for operating a network installed in the store or company when the event is event for drawing lots and a client who receives the notification of the event and applies for the event using the client's terminal includes the steps of:
obtaining inherent information such as the phone number of the terminal used for the event application;
giving lottery numbers by inherent information of the obtained terminals;
comparing the given lottery number with winning numbers set in the network installed in the store; and
notifying the compared result to the client's terminal.

18. An operating method of an informative service system for providing requested information if a owner of a terminal entering a special region requests special information within the region through Internet connection using the terminal, the operating method comprising the steps of:
receiving the requested information through a server network;
confirming the present position of the owner of the terminal who requests information; and
transmitting data of the requested information to the local CP network constructed in the confirmed location.

19. The method according to claim 18, wherein the step of providing the requested information through a local CP network includes the steps of:
searching the requested information from information stored on the basis of information received from the server network; and
transmitting the searched information to the corresponding terminal.

20. An operating method of an informative service system, if a client who enters a special region requests special information of the region using a terminal of the client, the method comprising the steps of:
transmitting the request of information received from the client to a local CP network through a network linking device of a base station receiving signal transmitted from the client's terminal, the local CP network having much information of the region where the client is located;
searching the requested information from information stored in the local CP network receiving the request of information; and
transmitting the searched information to the client's terminal.

21. An informative service system comprising:
a local CP network having a database storing information of stores located in a special region, an information obtaining part for continuously updating information of the stores located in the region, a classifying part for classifying the obtained information according to display precedence, and a transmitting part for transmitting the classified information to a terminal of a client;
a server network receiving information requested from the client and transmitting the requested information to the local CP network installed in the region where the client is located; and
a position confirmation network for continuously confirming the position of the client using signal generated from the client's terminal and providing the confirmed position information of the client to the server network.

22. An operating method of an informative service system comprising the steps of:
confirming the position of a client if the client requests information of stores for providing special service according to specified classification;
obtaining information of the stores, which are located in the region where the client is located, according to the specified classification;
classifying the stores according to display precedence based on a preferred order set using the obtained information; and
transmitting the classified information to the client's terminal.

23. The method according to claim 22, wherein the preferred order set based on information of the stores is selectively designated using various items such as nearer distance from the position of the client, the number that the client has visited the stores, evaluation of each store, and the number of inquiry of the corresponding store through a communication network.

24. The method according to claim 22, further comprising the steps of:
changing the display order according to items requested by the client if the client requests selection of the display precedence during classifying the stores according to the display order or displaying a list of the stores on the client's terminal based on the preferred display precedence; and
changing the items to designate the display order according to the existing items previously selected by the client or designate the display order according to basic items set in a classifying part if the client does not request the selection of the display order.

25. The method according to claim 22, further comprising the steps of displaying the present position of the client and a map showing the location of a selected store on the client's terminal if the client selects one of the listed stores displayed on the client's terminal.

26. The method according to claim 22, if the client selects one of the listed stores displayed on the client's terminal, further comprising the steps of:
searching a database and confirming other client's inquiry number of the store;
adding the client's inquiry number of the store to the confirmed inquiry number of the store; and
storing the added information in the database.

27. The method according to claim 22, if the client visits the corresponding store using information obtained through the client's terminal, further comprising the step of displaying a screen of evaluation request of the store through the client's terminal.

28. The method according to claim 27, wherein the screen of evaluation request is a differential evaluation item of the store and may be recalculated when the client selects one of the evaluation items.

29. The method according to claim 28, if the client selects one the differential evaluation items displayed on the client terminal, further comprising the steps of:
calculating evaluation grades corresponding to the selected item;
obtaining existing grades evaluated by other clients from the database;
recalculating an average evaluation grades of all clients after adding evaluation grades of the store calculated according to the client's selection to the grades obtained from the database; and
restoring the recalculated average evaluation grades in the database as the evaluation grades of the store.

30. An information service system comprising:
a database storing information of a standard location registered by the client, information of critical value of a difference in time and space from the standard location and information related with services provided according to the difference in time and space;
position confirming means for grasping the present position of the client;
time measuring means for counting time exceeding the critical value from the standard location registered by the client;
information obtaining means for obtaining information of services set according to the difference in time and space confirmed by the position confirming means and the time measuring means; and
information transmitting means for transmitting the obtained information to a terminal of a client.

31. The system according to claim 30, wherein all of the means are constructed according to the environment of a mobile communication system based on various networks.

32. An operating method of an informative service system comprising the steps of:
registering a standard location by a client;
continuously confirming the present position of the client;
confirming a difference in time and space between the confirmed present position of the client and an initially registered standard location; and
performing service set according to exceeded difference if the confirmed difference in time and space exceeds a critical value of the set difference in time and space.

33. The method according to claim 32, wherein the step of confirming the present position of the client is performed according to a period for confirming the set present position or performed according to a request of the client.

34. The method according to claim 32, wherein the step of confirming a difference in time and space between the confirmed present position of the client and an initially registered standard location is performed by confirming whether or not the client is out of the set critical distance from the initially registered standard location.

35. The method according to claim 32, wherein the service set according to exceeded difference if the confirmed difference in time and space is service for providing at least one of information of various e-mails received from the initially registered standard location to the client's account at a time point exceeding the critical value of the set difference in time and space, information available restaurants at the location where the client is located if it is a mealtime, and information of traffic for returning the client to the standard location.
